(19) United States
(12) Patent Application Publication
(10) Pub. No.: US 2002/0004782 A1
(43) Pub. Date: Jan. 10, 2002

(54) System and method for prepaying for services or goods to be consumed at a future date

(76) Inventor: David Cincotta, South Orange, NJ (US)

Correspondence Address: FITZPATRICK CELLA HARPER & SCINTO, 30 ROCKEFELLER PLAZA, NEW YORK, NY, 10112, US

(21) Appl. No.: 09/837,279

(22) Filed: Apr. 19, 2001

Related U.S. Application Data
(62) Division of application No. 09/245,493, filed on Feb. 5, 1999.

(51) Int. Cl. G06F 17/60

(52) U.S. Cl. 705/39; 705/26

(57) ABSTRACT

A method for allowing plural participants to prepay for services or goods to be received at a later date from one of plural specified providers is administered by an administrating entity. In the method, contracts are executed between the administrating entity and each participant in which the participant pays to the administrating entity a cash amount, and in return receives from the administrating entity a promise to deliver at a future date a specified measure of services or goods, to be provided by whichever of the specified providers the participant selects. Predicted total measures of services are goods that will be required from each provider by the aggregate of the participants are determined, and contracts are executed between the administrating entity and the providers in which the administrating entity pays to the contracting provider a specified amount, and in return receives from the provider a promise to deliver a specified measure of goods or services.

### BACKGROUND OF THE INVENTION

1. Field of the Invention

This invention relates to the field of financial data processing, and in particular relates to a data processing system for administering a plan whereby participants are able to prepay for goods and services which will be delivered and consumed at a later date.

2. Description of the Related Art

There are many situations in which an individual or group is certain or virtually certain that he, she or it will be incurring at some future date a relatively large expense in the connection with the purchase of goods or services, but is uncertain as to the entity from which the goods or services will be purchased. A well-known example is a parent who is certain or virtually certain that his or her child will be attending college after graduating from high school, but is of course uncertain as to the specific institution that the child will attend. The cost of funding a child's education represents a relatively large expense, and a prudent family typically begins planning as to how that expense will be met very early in the child's life.

The most common known way of doing this is by setting aside a certain amount of money periodically (such as, for example, monthly), and investing that money, so that by the time the child is ready to attend college there will be enough money to finance the education. This approach, however, has several drawbacks. To begin with, while it is relatively easy to ascertain what the tuitions are at various colleges and universities across the country at present, there is not an accurate method of predicting what tuitions will be by the time the child is ready to actually enroll, which may be five, ten, fifteen or more years into the future. Accordingly, it is very difficult for a parent to predict exactly how much money should be set aside.

Moreover, in order to minimize the amount of money that needs to be set aside but still end with a sum large enough to finance the child's education, many families choose relatively aggressive investment strategies for these savings, such as stocks, aggressive mutual funds and low grade bonds. Such investment strategies, however, are inherently risky, and may result in the child's total college savings portfolio being less than anticipated when the child is ready to attend college. If more conservative investment strategies are used, on the other hand, then more money will have to be set aside, creating an additional strain on the family's cash-flow. Further still, no matter what investment vehicles are chosen, the interest earned on the investments will be subject to taxation by the Federal, State and local governments. Such taxation further reduces the amount of money that ultimately will be in the child's portfolio when it will be needed, and/or further increases the amount of money that the family will need to set aside.

Several systems and methods have been suggested for addressing these problems. For example, some states have enacted legislation which allows parents to deduct a certain amount of money from their taxable state income per year if that money is placed in a qualified tuition savings plan. In addition, the interest earned on those savings may be tax exempt. These approaches, however, suffer from the same drawbacks as a standard savings plan, in that the money that the parents save is still subject to the inherent risks of the investment vehicles that are chosen. Also, such state legislation does not and cannot provide that the amount of monies saved may be deducted from the parents' taxable federal income, which would of course have a far greater impact.

U.S. Pat. Nos. 4,642,768 and 4,722,055, both to Roberts, describe an investment program which purports to provide a parent a future return adequate to pay the cost of a child's college education in return for a present investment determined on the basis of current college cost data and projections of the rate of increase of college costs. In these patents, securities are selected that offer a rate of return that matches the expected increase in education costs. There is no guarantee, however, that the actual increase in college costs will match the expected increase. Also, the return on the investments is still subject to taxation.

U.S. Pat. Nos. 5,745,885 and 5,809,484, both to Mottola et al., describe a program in which the tuition of students accepted into the program is paid for by funds invested by investors, in return for an agreement by the students to assign a percentage of their future income for a limited time period to the plan. This system, however, is merely a replacement for traditional student loan plans, such as the Stafford Loan program, the Perkins Loan program and the Supplemental Loan program, and requires a student, after graduation, to pay back money that was provided. It does not at all provide a mechanism that allows a parent to fund a child's educational costs.

In recent years, pre-paid college tuition programs have come into being, whereby a parent can in the present pay for all or part of a child's educational costs, at the present tuition rate, and receive the actual educational services that have been paid for when the child is old enough to attend college. The inherent problem with this approach, however, is that the parent is uncertain as to the particular institution that the child will be attending, since he or she will have no reliable way of gauging, particularly in the child's early years, the institutions which the child will want to attend, and the institutions to which the child will gain admittance. A pre-paid tuition program that involves only a single university, therefore, has limited practical applicability.

In attempt to solve this problem, consortiums which include several colleges and universities have been proposed, such as the proposed Tuition Plan, Inc. (“TPI”) consortium. Under the proposed TPI program, parents may purchase “certificates” of various denominations, which certificates cover a guaranteed percentage of education at any member institution, regardless of future tuition increases. The funds raised by the consortium through the sale of certificates will be invested by the consortium, and certain percentage of the principle plus the interest earned through those investments will go to a particular institution whenever a student enrolls.

With this program, however, the institutions are taking an investment risk, betting that the interest earned through the investments selected by the consortium will yield a return that will at least equal and preferably out-pace the increase in costs of educating a student. If the investments of the consortium do not yield such a return, however, the institutions will effectively be providing educational services to students enrolled in the plan at a loss to the institution. Such an eventuality may force institutions to cut their costs, reducing the overall quality of the education that all students receive.

There is a need, therefore, for a system and method that enables a consumer to prepay for services or goods to be consumed at a later date in an efficient and workable manner, and overcomes the drawbacks discussed above.

### SUMMARY OF THE INVENTION

It is a first object of the present invention to provide a system and method that enables a consumer to prepay for services or goods to be consumed at a later date.

It is another object of the present invention to provide a system and method that allows a consumer to prepay for such services or goods in situations where the consumer, at the time or the prepayments, will not know the entity from which he will want the services or goods to be provided.

It is yet another object of the present invention to provide a system and method which determines a predicted total measure of services or goods that a aggregate of consumers will want from each of a plurality of specified providers.

In accordance with one aspect of the present invention, a method for allowing a plurality of participants to prepay for services or goods to be received at a later date from one of a plurality of specified providers is administered by an administrating entity and includes the steps of executing contracts between the administrating entity and each of the participants in which a contracting participant pays to the administrating entity a cash amount and in return receives from the administrating entity a promise to deliver at a future date a specified measure of services or goods, the services or goods to be provided by whichever of the specified providers the contracting participant selects; determining, for each of the providers, a predicted total measure of services or goods that will be required from that provider by the aggregate of the participants; and executing contracts between the administrating entity and each of the providers in which the administrating entity pays to a contracting provider a cash amount and in return receives from the contracting provider a promise to deliver a specified measure of services or goods.

In another aspect of the present invention, a financial data processing system for allowing a plurality of participants to prepay for services or goods to be received at a later date from one of a plurality of specified providers comprises means for storing data regarding a plurality of contracts executed between an administrating entity and each of the participants in which a contracting participant paid to the administrating entity a cash amount and in return received from the administrating entity a promise to deliver at a future date a specified measure of services or goods, the services or goods to be provided by whichever of the specified providers the contracting participant selects; means for determining, for each of the providers, a predicted total measure of services or goods that will be required from that provider by the aggregate of the participants; and means for storing data regarding a plurality of contracts executed between the administrating entity and each of the providers in which the administrating entity paid to a contracting provider a cash amount and in return received from the contracting provider a promise to deliver a specified measure of services or goods.

In yet another aspect of the present invention a financial data processing system for allowing a plurality of participants to prepay for services or goods to be received at a later date from one of a plurality of specified providers, the choice of which of the plurality of providers will deliver the services or goods being made by a participant at the time the goods and services are to be delivered, comprises a machine-readable storage devices which stores data indicating measures of services or goods for which each participant has prepaid and measures of services or goods which each provider has contracted to provide; and a processing circuit for determining, for each of the providers, a predicted total measure of services or goods that will be required from that provider by the aggregate of the participants.

### BRIEF DESCRIPTION OF THE DRAWINGS

FIG. 1 is a block diagram illustrating one embodiment of hardware for implementing the present invention.

FIG. 2 is a flow chart illustrating one embodiment of the determination process of the present invention.

### DETAILED DESCRIPTION OF THE PREFERRED EMBODIMENTS

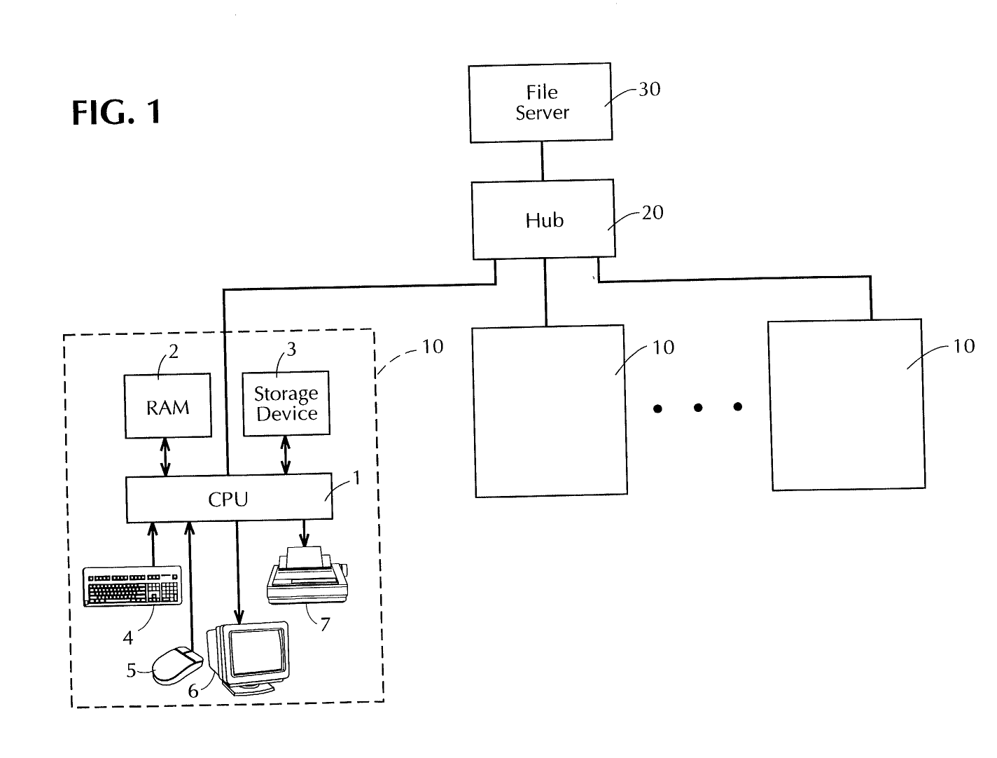

A basic hardware configuration with which the present invention may be implemented is depicted schematically in FIG. 1. This configuration is a local area network (“LAN”) which includes a plurality of individual workstations 10, a hub 20 and a file server 30. Each workstation includes a CPU 1, a random access memory (“RAM”) 2 and a storage device 3. The storage device 3 may comprise, for example, a floppy disk and drive, a hard disk and drive, a CD-ROM and drive, or the like, or any combination of the foregoing. Each work station further includes one or more input devices such as a keyboard 4 or a mouse 5, and one or more output devices, such as a monitor 6 or a printer 7. Each workstation 10 communicates with a central file server 30 through the hub 20, in a manner that will be readily apparent to those skilled in the art of networking.

In operation, a software program implementing the present invention may be stored in the storage device 3 of each workstation 10, so that the CPU 1 of each workstation 10 may execute the program when so directed by an operator. Alternatively, the software program, or a portion thereof, may be stored in the file server 30. Preferably, all data records that the software program creates (to be discussed in greater detail below) are stored in the file server 30, so that those data records may be accessed by any of the workstations 10. The file server 30 might also store other information that may need to be accessed by all of the workstations 10.

The hardware configuration depicted in FIG. 1, of course, is exemplary only, and countless other hardware configurations could be used to implement the present invention. For example, different LAN topologies might be used. If is desirable to locate the various workstations 10 in more than one building or complex, a metropolitan area network (“MAN”) configuration might be used; if it is desirable to locate the various workstations 10 in more than one city a wide area network (“WAN”) configuration might be used. On the other hand, if it is desirable to implement the invention using only a single computer only, no network may be necessary at all, and the data records may simply be stored in the storage device 3 of a single workstation 10. Further still, irrespective of the particular configuration used, additional hardware and software, such as a modem connected to a telephone line or to a dedicated data line, might be incorporated to allow stored information to be accessed remotely.

One preferred embodiment of the present invention is a system and method which effectively allows individuals such as parents to prepay their child's college tuition. A company formed to administer the System (the “Administrating Company”) will enlist several colleges and universities, preferably on the order of five hundred to one thousand or more colleges or universities across the country, to join as member institutions (the “Institutions”), and will maintain in a computer database a data record corresponding to each Institution. Each Institution's data record may include such information as the Institution's name, an Institution identification number, the location or locations of the Institution, the tuition it presently charges for a year of education, the Institution's tuition history, its telephone numbers, facsimile numbers, electronic mail addresses and the like. Each Institution's data record may further include statistical information describing the historical make-up of the Institution's student body, particularly with respect to factors such as, academic performance prior to admission, scholastic aptitude test (“SAT”) scores, declared majors, geographic origin, gender, ethnicity, religion, parents' education, and other factors which will aid in determining how likely a given child is to ultimately attend that Institution.

The Administrating Company will also create and maintain in a computer database a data record for each individual who participates in the System (a “Participant”). Each Participant's data record may include such information as the Participant's name, a Participant identification number, the Participant's address, telephone and facsimile numbers, electronic mail address and the like, as well as the name of a Beneficiary (such as, for example, the name of a particular child of the Participant) which the Participant specifies. Each Participant's data record may further include additional information concerning the Participant and/or the Beneficiary, particularly with respect to factors such as geographic locale, gender, ethnicity, religion, parents' education and other factors corresponding to the statistical information in the Institutions' data records. In addition, Participant data records may be updated as the Beneficiary goes through life, with such information as academic performance, SAT scores, exhibited preference for a particular major, and other factors corresponding to the statistical information in the Institutions' data records.

In the most basic form of the pre-paid college tuition embodiment, a Participant enrolling in the plan will enter into a contract with the Administrating Company whereby the Participant transfers to the Administrating Company some sum of money (a “Premium”), and in return receives from the Administrating Company a call option giving the Participant the right to purchase, at some point in the future, a specified measure of educational services for the Beneficiary from any one of the Institutions for a specified amount of money (the “Strike Price”). The choice of which Institution will actually provide the services is to be made at the sole discretion of the Participant, at the time the option is exercised. The option may be exercisable by the Participant at any time following the execution of the Contract up to its expiration date, or alternatively may be exercisable only after some specified date (a “Maturity Date”). The salient details of this contract, such as the amount of the Premium paid, the precise measure of educational services that may be purchased, the amount of the Strike Price, the Maturity Date and the date on which the option expires, will all become a part of the Participant's data record.

The option is preferably a deep-in-the-money option (a “DIM”), i.e., an option in which the Strike Price is very low in comparison to the Premium. For example, a Strike Price of one hundred dollars, ten dollars or even one dollar may correspond to a ten thousand dollar Premium, with the measure of educational services that may be purchased at the Strike Price being roughly equivalent to the measure of educational services that could have been purchased for ten thousand dollars at the time the contract was executed. The precise measure of services that each option will allow the participant to purchase will be decided by the Administrating Company, based upon the amount of money the Administrating Company needs to spend to purchase the forward contracts necessary to cover the options, as is discussed in greater detail below.

The measure of educational services that may be purchased at the Strike Price is preferably expressed in years of full-time enrollment, or fractions thereof. Alternatively, it may be expressed in terms of credit hours. To account for the fact that each of the various Institutions charge different amounts for the same measure of education, the contract may specify, for each member Institution, a separate and distinct measure of educational services that may be purchased. For example, the contract may specify that the Participant has an option to purchase one-year of education at a first Institution, one-half of a year of education at a second, more expensive Institution, or two years of education at a third, less expensive Institution, with the choice being made by the Participant at the time the option is exercised. For each Institution, however, the precise measure of education that may be purchased will correspond roughly to the measure of education that could have been purchased for the Premium amount at the time the contract was executed. In any event, all of this information will become part of the Participant's data record.

An alternative embodiment of the present invention addresses the issue of different Institutions charging different tuition in the following way: The measure of education that may be purchased is expressed in the contract as a year or a fraction of a year at a hypothetical normalized Institution, and an adjustment factor is assigned to each of the actual Institutions to reflect that Institution's deviation from the hypothetical norm. For example, the adjustment factor of an Institution at which the tuition is higher than the hypothetical normalized Institution might be 1.25; the adjustment factor of an Institution at which the tuition is lower than the hypothetical normalized Institution might be 0.75; and the adjustment factor of an Institution at which the tuition is the same as the hypothetical normalized Institution might be 1.00.

The actual measure of education at a particular Institution which the Participant may purchase at the Strike Price when the option is exercised can then be calculated by dividing the measure of educational services that may be purchased at the normalized Institution by the Institution's adjustment factor. With this approach, of course, all relevant information, such as the amount of normalized services that may be purchased and the individual Institution's adjustment factors at the time the contract was executed are also stored in the Participant's data record.

In practice, most Participants will want to pay smaller Premiums to the Administrating Company over a relatively long span of time, rather then paying one large Premium. For example, a typical Participant may want to pay one Premium per year over a span of five, ten or even fifteen years or more, as their Beneficiary child grows from infancy, through childhood, through adolescence, and becomes old enough to attend college. Other Participants may find it even easier to make one Premium payment each month over that time span, so that the payments parallel the payments of other bills, such as rents, mortgage payments, auto loan or lease payments, utility payments and the like.

One way to address this practicality is as follows: each time a Premium is paid, the Participant and the Administrating Company will enter into a new contract whereby the Participant obtains a new option to purchase, at some point in the future, another specified measure of educational services for the Beneficiary from any one of the Institutions for a Strike Price. With respect to this new contract, the precise measure of services will be roughly equivalent to the measure of services that could have been purchased for the Premium amount at the time the new contract was executed. Note that it is quite possible that tuition at some or all of the Institutions will have changed (in most cases risen, although in some cases dropped) since the last time the Participant paid a Premium and received an option, so that the measure of services which the Participant may purchase under the new option may well be different (in most cases smaller, although in some cases greater) than the measure that may be purchased under the old option, even though the same Premiums were paid for each.

Thus the new contract must specify for each institution the precise measure of educational services which the Participant is being given the option to purchase. Similarly, if the alternative embodiment discussed above is used, the contract must specify the measure of normalized services that may be purchased, and the adjustment factors for each Institution that are pertinent to that option. In any event, all of the salient details of each new contract as it is entered into will become a part of the Participant's data record.

It may be impracticable for the Administrating Company and the Participant to actually execute a new contract each and every time a Premium is paid, which may be as often as once every month or more. Accordingly, in one embodiment of the present invention, the Administrating Company will collect Premiums from participants as frequently as the Participants desire to provide them (such as, for example, once per month), but will actually execute the option contracts on a less frequent basis. For example, it may be desirous to enter into option contracts only once per year, once all or most of the member Institutions have announced what their new tuitions will be. In the meantime, the Premiums that the Participant provides can be placed by the Administrating Company into a managed fund, which will invest in low-risk securities such as bank money markets, government bonds and the like. With this approach, the Participant's balance of Premiums paid plus interest accrued would also become of part of the Participant's data record.

In a preferred aspect, the software program that implements the present invention is capable of processing a given Participant's data record to determine the total amount of educational services at a given Institution which the Participant has options to purchase under all of the contracts that have been executed, plus the outstanding balance of Premiums paid but not yet applied to a contract. This information may be provided in hard copy or electronic form to a Participant for whichever of the member Institutions are requested.

As the Administrating Company enrolls Participants and accumulates Premiums over a set time period (such as, for example, over a ninety day time period), it places the Premiums in a managed fund that invests in low-risk securities to preserve the capital. At the end of the set time period, the Administrating Company will use the accumulated Premiums to execute forward contracts with the Institutions, whereby in return for a cash payment an Institution agrees to provide, at some point in the future, a specified amount of educational services. Preferably, each Institution will be required to carry some type of bond or similar instrument to insure the Administrating Company against a circumstance where the Institution cannot deliver on its obligations, such as circumstances where an Institution goes out of business and the like. In any event, the salient details of these forward contracts, such as the amount of the cash payment and the precise amount of educational services (again preferably expressed in terms of years of full-time enrollment or fractions thereof), will become a part of the Institution's data record.

The forward contract may require that the Institution provide the educational services at any time following the execution of the Contract, or alternatively may be require that the Institution provide such services only after some specified date. In either case, this information will also become a part of the Institution's data record.

The variety (in terms of breadth of Institutions) and magnitude (in terms of amount of educational services contracted for) of the forward contracts entered into by the Administrating Company should be sufficient to meet or exceed the expected future demand for educational services at specific Institutions from the aggregate of the Participants. In this manner, the entering into these forward contracts by the Administrating Company converts the Participants' “naked” options (i.e., options in which the option writer does not own the underlying security position) to “covered” options (i.e., options in which the option writer does own the underlying security position), thereby greatly reducing the risk to the Participants.

A determination process that predicts the total measure of educational services that will be required from each Institution by the aggregate of the Participants will now be described. Generally speaking, this determination process is carried out by examining the nature of the student body who has historically attended each Institution, particularly with respect to a set of predetermined categories, and examining the nature of each named Beneficiary with respect to those categories. These data are then compared to determine how likely each Beneficiary is to attend each Institution, and then to determine how much education each Beneficiary will require from each Institution, based upon the likelihood that the Beneficiary will attend a given Institution and the total measure of educational services that has been promised to him. When these results are totalled for the aggregate of the Participants, a meaningful indication of the measure of educational services needed from each Institution is obtained.

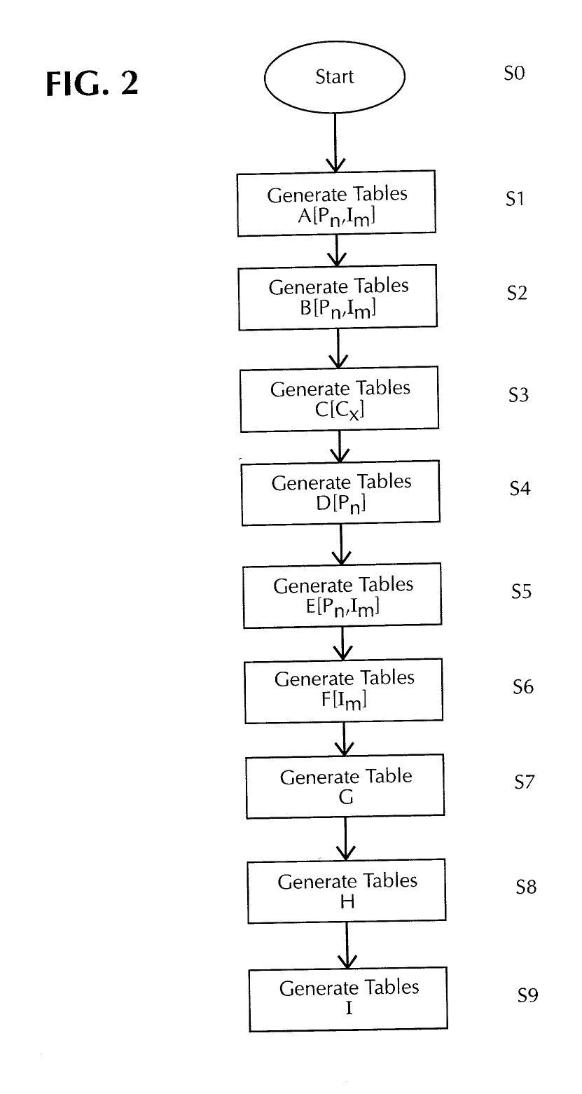

In one embodiment of the present invention, a table approach is used to carry out this determination process. A flow chart setting forth this embodiment is illustrated in FIG. 2.

The process begins at step S0. In step S1, the process generates a set of tables A. A separate table is generated for every combination of Participant and Institution, with each table A[Pₙ, Iₘ] corresponding to a particular Participant Pₙ and a particular Institution Iₘ. Each table A[Pₙ, Iₘ] includes a column YEAR for each year that the Participant Pₙ executed a contract with the Administrating Company; a column PREM for the amount of Premium paid in connection with that contract; a column TUIT for the tuition at the Institution Iₘ for that year; a column EDUC for the measure of educational services at the Institution Iₘ corresponding to that contract (i.e. the measure of education promised to the Participants Pₙ in that contract); a column MDAT for the Maturity Date of that contract; and a column EDAT for the expiration date of the contract. The entries in the EDUC column are preferably expressed as years or fractional years of full-time enrollment. The table A[Pₙ, Iₘ] may also include the total of the entries in the PREM column and the total of the entries in the EDUC column. All of the information required to generate the tables A[Pₙ, Iₘ] is available from the Participants' data record. An example of such a table A[P₁, I₁] is illustrated below:

TABLE A

| YEAR | PREM | TUIT | EDUC | MDAT | EDAT |
|---|---|---|---|---|---|
| 1995 | $ 3,000 | $10,000 | .3000 | 2004 | 2025 |
| 1996 | $ 2,500 | $10,500 | .2381 | 2005 | 2026 |
| 1997 | $ 4,500 | $11,025 | .4082 | 2005 | 2027 |
| 1998 | $ 1,200 | $11,578 | .1037 | 2006 | 2028 |
| 1999 | $ 6,000 | $12,155 | .4936 | 2006 | 2029 |
| TOTAL | $17,200 | | 1.5435 | | |

Next, in step S2, the process generates a set of tables B. A separate table is generated for every combination of Participant and Beneficiary, with each table B[Pₙ, Iₘ] corresponding to a particular Participant Pₙ and Institution Iₘ. Each table B[Pₙ, Iₘ] includes a column YEAR for each year from the present year to at least the year of expiration of the latest to expire contract; a column AGE for the age of the named Beneficiary in the given year; and a column MATU for the total measure of educational services at the Institution Iₘ corresponding to all contracts that will be matured and unexpired in that year. All of this information can be readily ascertained from the table A[Pₙ, Iₘ].

Each table B[Pₙ, Iₘ] further includes a column AVAILED for the available measure of educational services at the Institution Iₘ for the given year. Each entry for the AVAILED column is calculated as follows: zero if MATU for that year is zero, or else the value of AVAILED for the preceding year, less the expected measure of educational services redeemed in the preceding year (from the EXPED column, to be described below), plus the greater of zero and the difference between the entries in the current year's MATU column and the preceding year's MATU column.

Each table B[Pₙ, Iₘ] further includes a PENROLL column for the probability of the named Beneficiary enrolling in any college that year. This information is available from U.S. Government calculated statistics, based on the Beneficiary's age. Each table B[Pₙ, Iₘ] further includes a EXPED column for the expected measure of educational services that the Participant Pₙ will redeem that year, calculated by multiplying PENROLL by AVAILED for the present year; and a CUM column for the cumulative total of all entries in the EXPED column, calculated by adding the entry in the EXPED column for the present year to entry in the CUM for the preceding year. It will be understood that the entries in the EXPED column represent the expected measure of educational services that the Participant Pₙ will redeem that year, taking into account the probability of the Beneficiary enrolling in college and assuming that the enrollment will be at Institution Iₘ. This figure will be modified later by the probability of the Beneficiary Bₙ attending the particular Institution Iₘ, to obtain a predicted total measure of education that the Participant Pₙ will require from Institution Iₘ.

An example of a table B[P₁, I₁], corresponding to the prior example for the table A[P₁, I₁] is set forth below:

TABLE B

| YEAR | AGE | MATU | AVAILED | PENROLL | EXPED | CUM |
|---|---|---|---|---|---|---|
| 1999 | 12 | 0.0000 | 0.0000 | 0.0001% | 0.0000 | 0.0000 |
| 2000 | 13 | 0.0000 | 0.0000 | 0.0001% | 0.0000 | 0.0000 |
| 2001 | 14 | 0.0000 | 0.0000 | 0.0001% | 0.0000 | 0.0000 |
| 2002 | 15 | 0.0000 | 0.0000 | 0.0010% | 0.0000 | 0.0000 |
| 2003 | 16 | 0.0000 | 0.0000 | 0.0100% | 0.0000 | 0.0000 |
| 2004 | 17 | 0.3000 | 0.3000 | 10.0000% | 0.0300 | 0.0300 |
| 2005 | 18 | 0.9463 | 0.9163 | 65.0000% | 0.5956 | 0.6256 |
| 2006 | 19 | 1.5435 | 0.9180 | 80.0000% | 0.7344 | 1.3599 |
| 2007 | 20 | 1.5435 | 0.1836 | 95.0000% | 0.1744 | 1.5344 |
| 2008 | 21 | 1.5435 | 0.0092 | 80.0000% | 0.0073 | 1.5417 |
| 2009 | 22 | 1.5435 | 0.0018 | 65.0000% | 0.0012 | 1.5429 |
| 2010 | 23 | 1.5435 | 0.0006 | 25.0000% | 0.0002 | 1.5431 |
| 2011 | 24 | 1.5435 | 0.0005 | 10.0000% | 0.0000 | 1.5431 |
| 2012 | 25 | 1.5435 | 0.0004 | 1.0000% | 0.0000 | 1.5431 |
| 2013 | 26 | 1.5435 | 0.0004 | 0.1000% | 0.0000 | 1.5431 |
| 2014 | 27 | 1.5435 | 0.0004 | 0.1000% | 0.0000 | 1.5431 |
| 2015 | 28 | 1.5435 | 0.0004 | 0.1000% | 0.0000 | 1.5431 |
| 2016 | 29 | 1.5435 | 0.0004 | 0.1000% | 0.0000 | 1.5431 |
| 2017 | 30 | 1.5435 | 0.0004 | 0.1000% | 0.0000 | 1.5431 |
| 2018 | 31 | 1.5435 | 0.0004 | 0.1000% | 0.0000 | 1.5431 |
| 2019 | 32 | 1.5435 | 0.0004 | 0.1000% | 0.0000 | 1.5431 |
| 2020 | 33 | 1.5435 | 0.0004 | 0.1000% | 0.0000 | 1.5431 |
| 2021 | 34 | 1.5435 | 0.0004 | 0.1000% | 0.0000 | 1.5431 |
| 2022 | 35 | 1.5435 | 0.0004 | 0.1000% | 0.0000 | 1.5431 |
| 2023 | 36 | 1.5435 | 0.0004 | 0.1000% | 0.0000 | 1.5431 |
| 2024 | 37 | 1.5435 | 0.0004 | 0.1000% | 0.0000 | 1.5431 |
| 2025 | 38 | 1.5435 | 0.0004 | 0.1000% | 0.0000 | 1.5431 |
| 2026 | 39 | 1.2435 | 0.0004 | 0.1000% | 0.0000 | 1.5431 |
| 2027 | 40 | 1.0054 | 0.0004 | 0.1000% | 0.0000 | 1.5431 |
| 2028 | 41 | 0.5973 | 0.0004 | 0.1000% | 0.0000 | 1.5431 |
| 2029 | 42 | 0.4938 | 0.0004 | 0.1000% | 0.0000 | 1.5431 |
| 2030 | 43 | 0.0000 | 0.0000 | 0.0000% | 0.0000 | 1.5431 |
| 2031 | 44 | 0.0000 | 0.0000 | 0.0000% | 0.0000 | 1.5431 |
| 2032 | 45 | 0.0000 | 0.0000 | 0.0000% | 0.0000 | 1.5431 |
| 2033 | 46 | 0.0000 | 0.0000 | 0.0000% | 0.0000 | 1.5431 |
| 2034 | 47 | 0.0000 | 0.0000 | 0.0000% | 0.0000 | 1.5431 |
| 2035 | 48 | 0.0000 | 0.0000 | 0.0000% | 0.0000 | 1.5431 |

In step S3, the process determines for each Institution Iₘ a set of response factors RFₘ for each of several sub-categories within each of several categories. The response factors RFₘ for each sub-category will be used in determining the probability of a particular student enrolling in that Institution Iₘ, and is based on historical enrollment data provided by the Institution. The response factors should be such that, within each category, there is only one sub-category and hence one response factor that applies to any specified Beneficiary.

Some examples of useful categories and sub-categories are as follows: A category GPAₘ describes the make-up of the student body of Institution Iₘ with respect to the students' overall grade point averages (“GPAs”) in high school, and might include a sub-category for each of several ranges of GPAs (such as, for example, 3.76-4.00; 3.51-3.75; 3.26-3.50; 3.01-3.25 . . . 0.00-0.25), representing the proportion of students falling into each range. A category RANKₘ describes the make-up of the student body of Institution Iₘ with respect to the students' ranks in high school, and might include a sub-category for each of several ranges of class rankings (such as, for example, top 1%; top 1-5%; top 6-10%; top 11-20%; top 21-30% . . . top 91-100%), representing the proportion of students falling into each range. A category SATₘ describes the make-up of the student body of Institution Iₘ with respect to the students' performance on the SAT college entrance examination, and might include a sub-category for each of several ranges of SAT scores (such as, for example, 776-800; 751-775; 726-750; 701-725 . . . 200-225), representing the proportion of students falling into each range. If desirable, separate categories for math SAT scores and verbal SAT might also be used.

Another useful category is MAJORₘ, which describes the make-up of the student body with respect to declared majors, and might include a sub-category for each of several majors, such as, for example, ENGINEERINGₘ (any engineering major), SCIENCEₘ (any science major). ARTSₘ (any fine or performance arts major), BUSINESSₘ (any business related major), etc., plus a sub-category OTHERₘ (any other major) and a sub-category for UNDECLAREDₘ (major undeclared), each representing the proportion of students who have declared the particular major identified.

Other examples of useful categories and sub-categories are: A category GENDERₘ describes the gender make-up of the student body, and includes a sub-category MALEₘ representing the proportion of males and a sub-category FEMALEₘ representing the proportion of females. A category GEOGRAPHYₘ describes from where the student body originates, and might include a sub-category for each U.S. state (e.g. NEW YORKₘ, NEW JERSEYₘ, etc.) representing the proportion of students originating from that state and a sub-category FOREIGNₘ representing the proportion of students of foreign origin. A category ETHNICITYₘ describes the ethnic make-up of the student body, and might include a sub-category WHITEₘ representing the proportion of white students, a sub-category BLACKₘ representing the proportion of black students, a sub-category ASIANₘ representing the proportion of Asian students, a sub-category HISPANICₘ representing the proportion of Hispanic students and a sub-category OTHERₘ representing a proportion of students of other ethnic origins. A category RELIGIONₘ describes the religious make-up of the student body, and might include a sub-category CATHOLICₘ representing the proportion of Catholic students, a sub-category PROTESTANTₘ representing the proportion of Protestant students, a sub-category JEWISHₘ representing the proportion of Jewish students, a sub-category ISLAMₘ representing the proportion of Islamic students, a sub-category OTHERₘ representing the proportion of students of other religions and a sub-category NONEₘ representing the proportion of students of no specified religion.

Still other useful categories and sub-category are: A category PARENTSEDₘ describes the make-up of the student body with respect to the parent's education, and might include a sub-category DOCTORATEₘ representing the proportion of students having a parent who has received some type of doctorate degree, a sub-category GRADₘ representing the proportion of students having a parent who has received a graduate, non-doctorate degree, a sub-category BACHₘ representing the proportion of students having a parent who has received a bachelor's degree only, a sub-category SOMEₘ representing the proportion of students having a parent who has some college but not at least a bachelor's degree and a sub-category NONEₘ representing the proportion of students having no parent who has attended college. A category PARENTSALUMₘ which describes the extent to which the parents of the student body have graduated from that Institution Iₘ, and might include a sub-category LEGACYₘ representing the proportion of the students whose parents are alumni, and a sub-category NONLEGACYₘ representing the proportion of students whose parents are not.

Of course, it will be readily understood that the categories above and the sub-categories within each category are exemplary only, and not an exhaustive listing. Other sub-categories within the categories given above might be added, in order to describe the make-up of the student bodies with respect to those categories with even greater specificity; and other categories might be added, each with their own sub-categories, to describe other useful characteristics of the student bodies. Conversely, the determination process might be simplified by deleting some of the categories above, or by dividing some of the categories into fewer sub-categories (such as, for example, dividing the GPA category into only two sub-categories one for GPA's greater than 3.0 and one for GPA's less than 3.0).

Some examples of additional categories which might be useful include categories that relate to measured intelligence quotient (“IQ”), participation in varsity sports, participation in the band or orchestra, parental occupations, and the like.

The response factors RFₘ for each sub-category in each category Cₓ for each Institution Iₘ are calculated in step S3 in the following manner. For each category Cₓ, a table C[Cₓ] is generated which includes a column INSTIT with a entry for each Institution Iₘ and a column ENROLL with an entry representing the total historical enrollment for each Institution Iₘ. The entries in the ENROLL column are summed, and the entries for the next column ENFACT are calculated by dividing the corresponding entry in the ENROLL column by the sum of the ENROLL column, so that the entries in the ENFACT are enrollment factors representing the percentage that the historical enrollment of the given Institution Iₘ is of the total enrollment in all Institutions. The ENFACT column will sum to one-hundred percent. Then, a raw data column RAW for each sub-category is calculated, with the entries being the raw number of students from the historical total pool of the corresponding Institution Iₘ who fit the particular sub-category. Each of the RAW columns is summed. Then, a percentage data column % for each sub-category is calculated, with the entries being the entry from the RAW column for the corresponding sub-category and Institution Iₘ, divided by the total of the RAW column for the corresponding sub-category. Each of the % columns will sum to one-hundred percent. Finally, a response factor column RF is calculated for each sub-category, with the entries being calculated by dividing the entry from the % column for the corresponding sub-category and Institution Iₘ by entry from the ENFACT column for the corresponding Institution Iₘ. These response factors will be used in determining the predicted total measure of education that each Participant Pₘ will require from each Institution Iₘ, as set froth in greater detail below.

An example of a table C is set forth below. This example corresponds to forty Institutions 1 through 40 and a category GENDER, which has two sub-categories MALE and FEMALE:

TABLE C1

| | | | RAW | RAW | % | % | RF | RF |
|---|---|---|---|---|---|---|---|---|
| INSTIT | ENROLL | ENFACT | MALE | FEMALE | MALE | FEMALE | MALE | FEMALE |
| 1 | 1,346 | 3.58% | 916 | 430 | 4.80% | 2.32% | 1.34 | 0.65 |
| 2 | 1,810 | 4.81% | 569 | 1,241 | 2.98% | 6.70% | 0.62 | 1.39 |
| 3 | 849 | 2.26% | 697 | 152 | 3.65% | 0.82% | 1.62 | 0.36 |
| 4 | 392 | 1.04% | 12 | 380 | 0.06% | 2.05% | 0.06 | 1.97 |
| 5 | 1,556 | 4.14% | 390 | 1,166 | 2.04% | 6.30% | 0.49 | 1.52 |
| 6 | 1,627 | 4.33% | 118 | 1,509 | 0.62% | 8.15% | 0.14 | 1.88 |
| 7 | 892 | 2.37% | 774 | 118 | 4.06% | 0.64% | 1.71 | 0.27 |
| 8 | 1,627 | 4.33% | 1,591 | 36 | 8.34% | 0.19% | 1.93 | 0.04 |
| 9 | 1,766 | 4.70% | 419 | 1,347 | 2.20% | 7.27% | 0.47 | 1.55 |
| 10 | 951 | 2.53% | 208 | 743 | 1.09% | 4.01% | 0.43 | 1.59 |
| 11 | 194 | 0.52% | 186 | 8 | 0.98% | 0.04% | 1.89 | 0.08 |
| 12 | 69 | 0.18% | 19 | 50 | 0.10% | 0.27% | 0.54 | 1.47 |
| 13 | 1,311 | 3.49% | 1,030 | 281 | 5.40% | 1.52% | 1.55 | 0.44 |
| 14 | 147 | 0.39% | 69 | 78 | 0.36% | 0.42% | 0.93 | 1.08 |
| 15 | 67 | 0.18% | 28 | 39 | 0.15% | 0.21% | 0.82 | 1.18 |
| 16 | 899 | 2.39% | 197 | 702 | 1.03% | 3.79% | 0.43 | 1.59 |
| 17 | 311 | 0.83% | 185 | 126 | 0.97% | 0.68% | 1.17 | 0.82 |
| 18 | 1,778 | 4.73% | 1,046 | 732 | 5.48% | 3.95% | 1.16 | 0.84 |
| 19 | 1,289 | 3.43% | 841 | 448 | 4.41% | 2.42% | 1.29 | 0.71 |
| 20 | 340 | 0.90% | 309 | 31 | 1.62% | 0.17% | 1.79 | 0.19 |
| 21 | 1,783 | 4.74% | 1,779 | 4 | 9.33% | 0.02% | 1.97 | 0.00 |
| 22 | 523 | 1.39% | 85 | 438 | 0.45% | 2.37% | 0.32 | 1.70 |
| 23 | 612 | 1.63% | 125 | 487 | 0.66% | 2.63% | 0.40 | 1.62 |
| 24 | 1,784 | 4.75% | 484 | 1,300 | 2.54% | 7.02% | 0.53 | 1.48 |
| 25 | 1,472 | 3.92% | 1,278 | 194 | 6.70% | 1.05% | 1.71 | 0.27 |
| 26 | 1,081 | 2.88% | 286 | 795 | 1.50% | 4.29% | 0.52 | 1.49 |
| 27 | 1,350 | 3.59% | 903 | 447 | 4.73% | 2.41% | 1.32 | 0.67 |
| 28 | 740 | 1.97% | 366 | 374 | 1.92% | 2.02% | 0.97 | 1.03 |
| 29 | 722 | 1.92% | 252 | 470 | 1.32% | 2.54% | 0.69 | 1.32 |
| 30 | 1,034 | 2.75% | 592 | 442 | 3.10% | 2.39% | 1.13 | 0.87 |
| 31 | 271 | 0.72% | 105 | 166 | 0.55% | 0.90% | 0.76 | 1.24 |
| 32 | 540 | 1.44% | 254 | 286 | 1.33% | 1.54% | 0.93 | 1.08 |
| 33 | 1,106 | 2.94% | 41 | 1,065 | 0.21% | 5.75% | 0.07 | 1.95 |
| 34 | 600 | 1.60% | 471 | 129 | 2.47% | 0.70% | 1.55 | 0.44 |
| 35 | 865 | 2.30% | 643 | 222 | 3.37% | 1.20% | 1.47 | 0.52 |
| 36 | 1,037 | 2.76% | 466 | 571 | 2.44% | 3.08% | 0.89 | 1.12 |
| 37 | 1,288 | 3.43% | 714 | 574 | 3.74% | 3.10% | 1.09 | 0.90 |
| 38 | 66 | 0.18% | 18 | 48 | 0.09% | 0.26% | 0.54 | 1.48 |
| 39 | 13 | 0.03% | 8 | 5 | 0.04% | 0.03% | 1.21 | 0.78 |
| 40 | 1,488 | 3.96% | 602 | 886 | 3.16% | 4.78% | 0.80 | 1.21 |
| | 37,596 | 100.00% | 19,067 | 18,520 | 100.00% | 100.00% | | |

Another example of a table C is set forth below. This example corresponds to the same forty Institutions 1 through 40 and a category GPA, which has two subcategories >3.0 and <3.0:

TABLE C2

| | | | RAW | RAW | % | % | RF | RF |
|---|---|---|---|---|---|---|---|---|
| INSTIT | ENROLL | ENFACT | >3.0 | <3.0 | >3.0 | <3.0 | >3.0 | <3.0 |
| 1 | 1,346 | 3.58% | 1,218 | 128 | 6.62% | 0.67% | 1.85 | 0.19 |
| 2 | 1,810 | 4.81% | 410 | 1,400 | 2.23% | 7.30% | 0.46 | 1.52 |
| 3 | 849 | 2.26% | 107 | 742 | 0.58% | 3.87% | 0.26 | 1.71 |
| 4 | 392 | 1.04% | 331 | 61 | 1.80% | 0.32% | 1.72 | 0.30 |
| 5 | 1,556 | 4.14% | 254 | 1,302 | 1.38% | 6.78% | 0.33 | 1.64 |
| 6 | 1,627 | 4.33% | 968 | 659 | 5.26% | 3.43% | 1.22 | 0.79 |
| 7 | 892 | 2.37% | 561 | 331 | 3.05% | 1.72% | 1.28 | 0.73 |
| 8 | 1,627 | 4.33% | 1,499 | 128 | 8.14% | 0.67% | 1.88 | 0.15 |
| 9 | 1,766 | 4.70% | 813 | 953 | 4.42% | 4.97% | 0.94 | 1.06 |
| 10 | 951 | 2.53% | 390 | 561 | 2.12% | 2.92% | 0.84 | 1.16 |
| 11 | 194 | 0.52% | 48 | 146 | 0.26% | 0.76% | 0.51 | 1.47 |
| 12 | 69 | 0.18% | 69 | — | 0.37% | 0.00% | 2.04 | — |
| 13 | 1,311 | 3.49% | 845 | 466 | 4.59% | 2.43% | 1.32 | 0.70 |
| 14 | 147 | 0.39% | 97 | 50 | 0.53% | 0.26% | 1.35 | 0.67 |
| 15 | 67 | 0.18% | 45 | 22 | 0.24% | 0.11% | 1.37 | 0.64 |
| 16 | 899 | 2.39% | 247 | 642 | 1.34% | 3.40% | 0.56 | 1.42 |
| 17 | 311 | 0.83% | 1 | 310 | 0.01% | 1.62% | 0.01 | 1.95 |
| 18 | 1,778 | 4.73% | 1,492 | 286 | 8.11% | 1.49% | 1.71 | 0.32 |
| 19 | 1,289 | 3.43% | 338 | 951 | 1.84% | 4.96% | 0.54 | 1.45 |
| 20 | 340 | 0.90% | 173 | 167 | 0.94% | 0.87% | 1.04 | 0.96 |
| 21 | 1,783 | 4.74% | 949 | 834 | 5.16% | 4.35% | 1.09 | 0.92 |
| 22 | 523 | 1.39% | 134 | 389 | 0.73% | 2.03% | 0.52 | 1.46 |
| 23 | 612 | 1.63% | 567 | 45 | 3.08% | 0.23% | 1.89 | 0.14 |
| 24 | 1,784 | 4.75% | 237 | 1,547 | 1.29% | 8.06% | 0.27 | 1.70 |
| 25 | 1,472 | 3.92% | 907 | 565 | 4.93% | 2.94% | 1.26 | 0.75 |
| 26 | 1,081 | 2.88% | 751 | 330 | 4.08% | 1.72% | 1.42 | 0.60 |
| 27 | 1,350 | 3.59% | 1,036 | 314 | 5.63% | 1.64% | 1.57 | 0.46 |
| 28 | 740 | 1.97% | 444 | 296 | 2.41% | 1.54% | 1.23 | 0.78 |
| 29 | 722 | 1.92% | 478 | 244 | 2.60% | 1.27% | 1.35 | 0.66 |
| 30 | 1,034 | 2.75% | 188 | 846 | 1.02% | 4.41% | 0.37 | 1.60 |
| 31 | 271 | 0.72% | 154 | 117 | 0.84% | 0.61% | 1.16 | 0.85 |
| 32 | 540 | 1.44% | 435 | 105 | 2.36% | 0.55% | 1.65 | 0.38 |
| 33 | 1,106 | 2.94% | 652 | 454 | 3.54% | 2.37% | 1.20 | 0.80 |
| 34 | 600 | 1.60% | 230 | 370 | 1.25% | 1.93% | 0.78 | 1.21 |
| 35 | 865 | 2.30% | 204 | 661 | 1.11% | 3.44% | 0.48 | 1.50 |
| 36 | 1,037 | 2.76% | 520 | 517 | 2.83% | 2.69% | 1.02 | 0.98 |
| 37 | 1,288 | 3.43% | 73 | 1,215 | 0.40% | 6.33% | 0.12 | 1.85 |
| 38 | 66 | 0.18% | 56 | 10 | 0.30% | 0.05% | 1.73 | 0.30 |
| 39 | 13 | 0.03% | 13 | — | 0.07% | 0.00% | 2.04 | — |
| 40 | 1,488 | 3.96% | 471 | 1,017 | 2.56% | 5.30% | 0.65 | 1.34 |
| | 37,596 | 100.00% | 18,405 | 19,191 | 100.00% | 100.00% | | |

In step S4, a set of tables D is generated, consisting of one table D[Pₙ] for each Participant Pₙ. Each table includes the same INSTIT, ENROLL and ENFACT columns that are in the tables C, plus a column PROB representing the probability that the Beneficiary Bₙ of the Participant Pₙ will attend each Institution. Each entry in the PROB column is calculated by multiplying the corresponding entry from the ENFACT column by the corresponding entry from one and only one of the response factor RF columns from as many of the tables C[Cₓ] as may be applicable to the Beneficiary Bₙ at the present stage of his life. The particular response factor RF that is chosen from each table C[Cₓ] is the response factor RF which corresponds to the sub-category that describes the Beneficiary Bₙ. If a particular table C[Cₓ] relates to a category Cₓ which is inapplicable to a particular Beneficiary Bₙ at his present stage of life (such as, for example, the case of a table corresponding to the category GPA and a three-year old Beneficiary), then no response factor is taken from that table C[Cₓ].

An example of a table D is set forth below. This example corresponds to the same forty Institutions 1 through 40 given above, and a particular Beneficiary who is male and has a present GPA greater than 3.0, and assumes a very simplified model in which only two categories GENDER and GPA are used in the determination process. In this example, the entries in the PROB column were calculated by multiplying the corresponding entry in the ENFACT column by the corresponding entry in the RF MALE column of the GENDER table and then by the corresponding entry in the RF>3.0 column in the GPA table:

TABLE D

| INSTIT | ENROLL | ENFACT | PROB |
|---|---|---|---|
| 1 | 1,346 | 3.58% | 8.88% |
| 2 | 1,810 | 4.81% | 1.38% |
| 3 | 849 | 2.26% | 0.94% |
| 4 | 392 | 1.04% | 0.11% |
| 5 | 1,556 | 4.14% | 0.68% |
| 6 | 1,627 | 4.33% | 0.75% |
| 7 | 892 | 2.37% | 5.21% |
| 8 | 1,627 | 4.33% | 15.70% |
| 9 | 1,766 | 4.70% | 2.07% |
| 10 | 951 | 2.53% | 0.91% |
| 11 | 194 | 0.52% | 0.49% |
| 12 | 69 | 0.18% | 0.20% |
| 13 | 1,311 | 3.49% | 7.11% |
| 14 | 147 | 0.39% | 0.49% |
| 15 | 67 | 0.18% | 0.20% |
| 16 | 899 | 2.39% | 0.58% |
| 17 | 311 | 0.83% | 0.01% |
| 18 | 1,778 | 4.73% | 9.40% |
| 19 | 1,289 | 3.43% | 2.36% |
| 20 | 340 | 0.90% | 1.68% |
| 21 | 1,783 | 4.74% | 10.14% |
| 22 | 523 | 1.39% | 0.23% |
| 23 | 612 | 1.63% | 1.24% |
| 24 | 1,784 | 4.75% | 0.69% |
| 25 | 1,472 | 3.92% | 8.43% |
| 26 | 1,081 | 2.88% | 2.13% |
| 27 | 1,350 | 3.59% | 7.42% |
| 28 | 740 | 1.97% | 2.35% |
| 29 | 722 | 1.92% | 1.79% |
| 30 | 1,034 | 2.75% | 1.15% |
| 31 | 271 | 0.72% | 0.64% |
| 32 | 540 | 1.44% | 2.19% |
| 33 | 1,106 | 2.94% | 0.26% |
| 34 | 600 | 1.60% | 1.93% |
| 35 | 865 | 2.30% | 1.62% |
| 36 | 1,037 | 2.76% | 2.50% |
| 37 | 1,288 | 3.43% | 0.43% |
| 38 | 66 | 0.18% | 0.16% |
| 39 | 13 | 0.03% | 0.09% |
| 40 | 1,488 | 3.96% | 2.04% |
| | 37,596 | 100.00% | |

Next, in step S5, a set of tables E is generated. A separate table is generated for each combination of Participant and Institution, with each table E[Pₙ, Iₘ] corresponding to a particular Participant Pₙ and Institution Iₘ. Each table E[Pₙ, Iₘ] includes the YEAR and EXPED columns from table B[Pₙ, Iₘ], and a third column PREDED representing the actual prediction of how much education Participant Pₙ will require from Institution Iₘ. The entries for the PREDED column are calculated simply by multiply the corresponding entry in the EXPED column by the entry in the PROB column from the table D[Pₙ] for the corresponding Institution I ₘ.

An example of a table E[P₁, I₁], corresponding to the prior example for the tables A[P₁, I₁] and B[P₁, I₁] and assuming a hypothetical PROB of 0.15%, is set forth below:

TABLE E

| YEAR | EXPED | PREDED |
|---|---|---|
| 1999 | 0.0000 | 0.0000 |
| 2000 | 0.0000 | 0.0000 |
| 2001 | 0.0000 | 0.0000 |
| 2002 | 0.0000 | 0.0000 |
| 2003 | 0.0000 | 0.0000 |
| 2004 | 0.3000 | 0.0000 |
| 2005 | 0.5958 | 0.0009 |
| 2006 | 0.7344 | 0.0011 |
| 2007 | 0.1744 | 0.0003 |
| 2008 | 0.0073 | 0.0000 |
| 2009 | 0.0012 | 0.0000 |
| 2010 | 0.0002 | 0.0000 |
| 2011 | 0.0000 | 0.0000 |
| 2012 | 0.0000 | 0.0000 |
| 2013 | 0.0000 | 0.0000 |
| 2014 | 0.0000 | 0.0000 |
| 2015 | 0.0000 | 0.0000 |
| 2016 | 0.0000 | 0.0000 |
| 2017 | 0.0000 | 0.0000 |
| 2018 | 0.0000 | 0.0000 |
| 2019 | 0.0000 | 0.0000 |
| 2020 | 0.0000 | 0.0000 |
| 2021 | 0.0000 | 0.0000 |
| 2022 | 0.0000 | 0.0000 |
| 2023 | 0.0000 | 0.0000 |
| 2024 | 0.0000 | 0.0000 |
| 2025 | 0.0000 | 0.0000 |
| 2026 | 0.0000 | 0.0000 |
| 2027 | 0.0000 | 0.0000 |
| 2028 | 0.0000 | 0.0000 |
| 2029 | 0.0000 | 0.0000 |
| 2030 | 0.0000 | 0.0000 |
| 2031 | 0.0000 | 0.0000 |
| 2032 | 0.0000 | 0.0000 |
| 2033 | 0.0000 | 0.0000 |
| 2034 | 0.0000 | 0.0000 |
| 2035 | 0.0000 | 0.0000 |

In step S6, a set of tables F is generated to determine the total predicted measure of education that will be required from each Institution. A separate table is generated for each Institution, with each table F[Iₘ] corresponding to a particular Institution Iₘ. Each table F[Iₘ] includes a YEAR column for as many years as necessary, and a column for each Participant Pₙ. The entries in each column Pₙ are taken from the entries in the PREDED column from table E[Pₙ, Iₘ] for the corresponding years. Each table F[Iₘ] further includes a TOTAL column, the entries for which are calculated by summing the entries in each column Pₙ for each given year.

In step S7, a single table G is generated which includes a column YEAR for as many years as necessary and a column for each Institution Iₘ. The entries in each column Iₘ are taken from the entries in the TOTAL column from table F[Iₘ] for the corresponding years. The table G further includes a TOTAL column, the entries for which are calculated by summing the entries in each column Iₘ for each given year. In this way, the table G represents the predicted total measure of education that will be required from each Institution, as well as the predicted total measure of education that will be required from all Institutions.

In step S8, an inventory table H is generated which includes a column YEAR for as many years as necessary and a column for each Institution Iₘ. The entries in each column Iₘ represent the measure of education that becomes available to the Administrating Company from the Institution Iₘ as of that year, as a result of contracts that the Administrating Company has executed with the Institution Iₘ. This information is available from the individual Institution's data records. The table H further includes a TOTAL column, the entries for which are calculated by summing the entries in each column Iₘ for each given year. In this way, the table H represents how much education will be available to cover Participant requirements, as well as the total measure of education that will be available from all Institutions.

In step S9, a table I is generated by subtracting table H from table G, so that the information therein represents the shortfall or surplus, based on the calculated predictions, of educational services at each Institution The resultant table I may then be examined by the Administrating Company in making its determinations as to what contracts should be executed with what Institutions. Note that because the information in Table I is based on predictions, which by their nature may not be one hundred percent accurate, the Administrating Company will not necessarily strictly adhere to the results therein, but instead may use it as a guide in making its contracting decisions. For example, the Administrating Company may use an approach wherein it does not enter into any new contracts with institutions as to which there is surplus of education, and enters into contracts with Institutions as to which there is a shortfall of education sufficient to cover the amount of the shortfall plus some additional amount, such as for example an additional five or ten percent. By way of another example, the Administrating Company may use an approach wherein part of any surplus of education that it may have is sold to third-parties, or is donated to third-parties in the form of scholarships and the like. Other approaches, of course, are possible as well, so long as the contracting decisions are made in accordance with the calculated predictions.

The determination process described above and depicted in FIG. 2 can be repeated as frequently as desired, such as for example annually, quarterly, monthly or even daily. Preferably, the Participants will provide the Administrating Company with updates concerning their Beneficiaries as they become available, such as for example their Beneficiaries' academic performance, special interests, intended majors, SAT scores and the like. Also, the Institutions will preferably provide the Administrating Company with updates as to the demographics of their student bodies from time to time. All of these updates will make the determination process more accurate as a predictor of the measure of educational services for which the Administrating Company should contract.

As a Beneficiary comes closer to attending college, even more helpful information should be provided, such as a listing of specific Institutions the Beneficiary may be interested in attending, a listing of specific Institutions to which the Beneficiary has applied, a listing of specific Institutions to which the Beneficiary has been accepted and from which the Beneficiary has been rejected, and ultimately an identification of the specific school in which the Beneficiary will enroll. As this information is provided, the Administrating Company may then modify its tables to distribute the Beneficiaries' probability of enrollment among only those schools in which he is interested, to which he has applied, to which he has been accepted, and ultimately to which he will enroll. All of these updates will make the determination process even more accurate, and ultimately virtually one hundred percent accurate with respect to the given Beneficiary, and therefore more accurate overall.

It will be readily appreciated that the table approach described above and depicted in FIG. 2 represents only one specific embodiment of the determining process of the present invention, and that a myriad of alternative embodiments for carrying out the determining process are possible.

When a named Beneficiary is ready to enroll in a certain Institution, the Participant may exercise all of the options (or part of the options) that have been acquired by requesting a voucher from the Administrating Company the educational services which the Administrating Company has contracted to provide, and paying to the Administrating Company the requisite Strike Price or Strike Prices. Upon such a request, the Administrating Company will provide to the Participant a voucher for the specified measure of services, preferably expressed in terms of years or fractional years at a specified Institution. Once a voucher for a certain measure of services has been provided, the Participant's data record is updated to reflect that the Participant now has exercised his options (or part of his options, as the case may be), and now has options on a new, lesser measure of educational services (or no more options, as the case may be). The particular Institution's data record is also updated to reflect that a voucher has been issued which when redeemed will require the Institution to actually provide a certain amount of educational services in fulfillment of one of the earlier entered into forward contracts with the Administrating Company.

When a voucher issued by the Administrating Company is presented to an Institution, the Institution will honor the voucher by providing to the Beneficiary the specified measure of educational services. Honoring the voucher may take the form of, for example, enrolling the Beneficiary in the Institution as a full-time student for the specified amount of time, such as four years, three years, two years, one year or one semester. The Institution will then advise the Administrating Company that it has honored a voucher in fulfillment of its obligations under a forward contract or contracts, or a portion thereof, and the Administrating Company will in turn update the Institution's data record accordingly.

In the above examples, the Participants receive from the Administrating Company promises to provide educational services at a future date in the form of an option, preferably a DIM option, to purchase those services; and the Administrating Company receives from the Institutions promises to deliver educational service at a future date in the form of a forward contract. It will be understood that other permutations of this arrangement are possible as well.

For example, in alternative embodiments of the present invention, the Administrating Company may enter into forward contracts with the Participant, whereby the Administrating Company contracts to provide the Participant with a specified amount of educational services at a future date, and may acquire options, preferably DIM options, from the Institutions which give the Administrating Company the right to purchase educational services at a future date at a Strike Price. In yet another alternative embodiment of the present invention, both the Participant and the Administrating Company and the Administrating Company and the Institutions enter into forward contract. In still another alternative embodiment of the present invention, both the Participant and the Administrating Company acquire options, preferably DIM options, to purchase educational services in the future.

Other variations to the above-described examples are possible as well. For example, the Administrating Company may allow a Participant to change the Beneficiary (such as, for example, from one child to another) by notifying the Administrating Company and paying a modest transaction fee. The Administrating Company would then change the name of the Beneficiary, and other data concerning the Beneficiary, in the Participant's data record. Alternatively, the Administrating Company may provide that no specific Beneficiary need be named until the time of actual enrollment at a Institution. This alternative would give a greater amount of flexibility to the Participant, but would make it more difficult for the Administrating Company to determine the variety and magnitude of the educational services that it must contract with the Institutions to provide, since it would have only general data relating to the Participant family (such as geographic data, ethnicity, religion, parental education and the like), and not data relating to a specific future student (such as academic performance data, gender and the like).

It will be readily appreciated that the present invention has broad applicability beyond the prepaid college tuition plan embodiment given as example above. For example, the present invention might be used to implement a prepaid tuition plan for graduate schools, or for private secondary schools, elementary schools or pre-kindergarten schools. Other applications include, but are in no way limited to, a plan for prepaying for vacation or travel; a plan for prepaying for automobiles, boats, motorcycles, airplanes, recreation vehicles and the like; and a plan for prepaying for home furnishings; a plan for prepaying for medical services, dental services and the like. As the present invention is applied to different environments, suitable categories must be selected which allow the measure of goods or services that will be required from each supplier by the aggregate of the Participants to be predicted.

What we claim:

1. A method, to be administered by an administrating entity, for allowing a plurality of participants to prepay for services or goods to be received at a later date from one of a plurality of specified providers, the method comprising the steps of:
executing contracts between the administrating entity and each of the plurality of participants in which a contracting participant pays to the administrating entity a cash amount and in return receives from the administrating entity a promise to deliver at a future date a specified measure of services or goods, the services or goods to be provided by whichever of the plurality of specified providers the contracting participant selects;
determining, for each of the plurality of specified providers, a predicted total measure of services or goods that will be required from that provider by the aggregate of the plurality of participants; and
executing contracts between the administrating entity and each of the plurality of specified providers in which the administrating entity pays to a contracting provider a cash amount and in return receives from the contracting provider a promise to deliver a specified measure of services or goods.

2. A method according to claim 1, wherein the administrating entity ascertains the measure of services or goods to be specified in each contract with a provider in accordance with the predicted total measure of services or goods that will be required from that provider.

3. A financial data processing system for allowing a plurality of participants to prepay for services or goods to be received at a later date from one of a plurality of specified providers comprising:
means for storing data regarding a plurality of contracts executed between an administrating entity and each of the plurality of participants in which a contracting participant paid to the administrating entity a cash amount and in return received from the administrating entity a promise to deliver at a future date a specified measure of services or goods, the services or goods to be provided by whichever of the plurality of specified providers the contracting participant selects;
means for determining, for each of the plurality of specified providers, a predicted total measure of services or goods that will be required from that provider by the aggregate of the plurality of participants; and
means for storing data regarding a plurality of contracts executed between the administrating entity and each of the plurality of specified providers in which the administrating entity paid to a contracting provider a cash amount and in return received from the contracting provider a promise to deliver a specified measure of services or goods.

4. A financial data processing system according to claim 1, wherein the administrating entity ascertains the measure of services or goods to be specified in each contract with a provider in accordance with the predicted total measure of services or goods that will be required from that provider.

5. A financial data processing system for allowing a plurality of participants to prepay for services or goods to be received at a later date from one of a plurality of specified providers, the choice of which of the plurality of providers will deliver the services or goods being made by a participant at the time the goods and services are to be delivered:
a machine-readable storage devices which stores data indicating measures of services or goods for which each participant has prepaid and measures of services or goods which each provider has contracted to provide;
a processing circuit for determining, for each of the providers, a predicted total measure of services or goods that will be required from that provider by the aggregate of the plurality of participants.
